(19) United States
(12) Patent Application Publication
(10) Pub. No.: US 2008/0154874 A1
(43) Pub. Date: Jun. 26, 2008

(54) PROVIDING MORE RELEVANT ANSWER TO A QUERY VIA QUERY AND/OR ANSWER PROCESSING

(76) Inventors: William Noah Schilit, Menlo Park, CA (US); Barbara Rosario, Berkeley, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/614,519

(22) Filed: Dec. 21, 2006

(51) Int. Cl. G06F 17/30

(52) U.S. Cl. 707/5; 707/E17.108

(57) ABSTRACT

A system, apparatus, and method to receive information from a device on a network and use the information to modify a query or an answer to the query with the information are described herein.

### TECHNICAL FIELD

Embodiments of the present invention relate to the field of data processing. More specifically, various embodiments relate to methods and systems for providing more relevant answers to a query.

### BACKGROUND

Advances in processor, networking, and related technologies have led to the availability of an abundant amount of information, accessible to a user at his/her fingertips through the use of a networked computing device. This abundant availability of information, however, can become frustrating at times with the relevant information buried under a mountain of irrelevant information.

Recently, home networks, and networks in general, connecting more than one network device have become popular fueled by many factors including the growth of broadband internet usage and the proliferation of digital media. As a result, an unprecedented level of complexity is being created for the home and office consumer. When networking problems arise, consumers will often formulate queries and present them through email, telephone, or online chat to a support technician, or simply present the query to the internet at-large through an internet search engine. These queries receive imprecise and often ineffectual answers, in part, because it is difficult for the consumer to formulate a well-framed query, and in part because of the volume of information available. Consequently, the consumer fails to find a viable solution to their problem in a timely manner and the business entity responsible for supplying the technical support is required to allocate large amounts of time and revenue into researching and solving the consumer's problems.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a block diagram of an exemplary digital home network environment coupled with different home network devices, including a host platform, in accordance with various embodiments of the present invention;

FIG. 2 illustrates a multi-processor platform system in a digital home network as presented in FIG. 1 in further detail, in accordance with various embodiments;

FIG. 3 illustrates a processor platform system in a digital home network as presented in FIG. 2 in further detail, in accordance with various embodiments;

FIG. 4 illustrates a flow diagram view of a portion of the operations of a host device in accordance with various embodiments of the present invention; and

FIG. 5 illustrates a flow diagram view of a portion of the operations of a host device as presented in FIG. 4 in further detail, in accordance with various embodiments;

### DETAILED DESCRIPTION OF EMBODIMENTS OF THE INVENTION

Various embodiments, described below, have been developed in response to the current state of the art and, in particular, in response to the previously identified problems and factors associated with queries based on network configurations that have not been solved by currently available systems, e.g. email support services, telephony support services, online chat-room support services, and information available through the internet at-large. Embodiments provide more relevant answer to a query. Embodiments provide a method for a host device to receive device specific information associated with a device within a network, create a list of synonymous terms correlated to the device specific information, and finally, to use the list of synonymous terms to modify a query. The modification of the query can occur prior to submitting a query by concatenating or expanding a query with the synonymous terms thereby creating a well-framed question; or modification can occur by submitting the query as received and ranking the results based on the list of synonymous terms thereby creating answers ranked by relevance. Exemplary device specific information received by the host device includes product categories, model numbers, manufacturer names, and firmware versions of devices within the network.

In the following detailed description, reference is made to the accompanying drawings which form a part hereof, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

For ease of understanding, the description will be in large part presented in the context of home networking; however, the present invention is not so limited, and may be practiced to provide more relevant answers to a variety of queries. Reference in the specification to a network “device” and/or “appliance” means that a particular feature, structure, or characteristic, namely device operable connectivity, such as the ability for the device to be connected to communicate across the network, and/or programmability, such as the ability for the device to be configured to perform designated functions, is included in at least one embodiment of the digital device as used herein. Typically, digital devices may include general and/or special purpose computing devices, connected personal computers, network printers, network attached storage devices, voice over internet protocol devices, security cameras, baby cameras, media adapters, entertainment personal computers, and/or other networked devices suitably configured for practicing the present invention in accordance with at least one embodiment.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

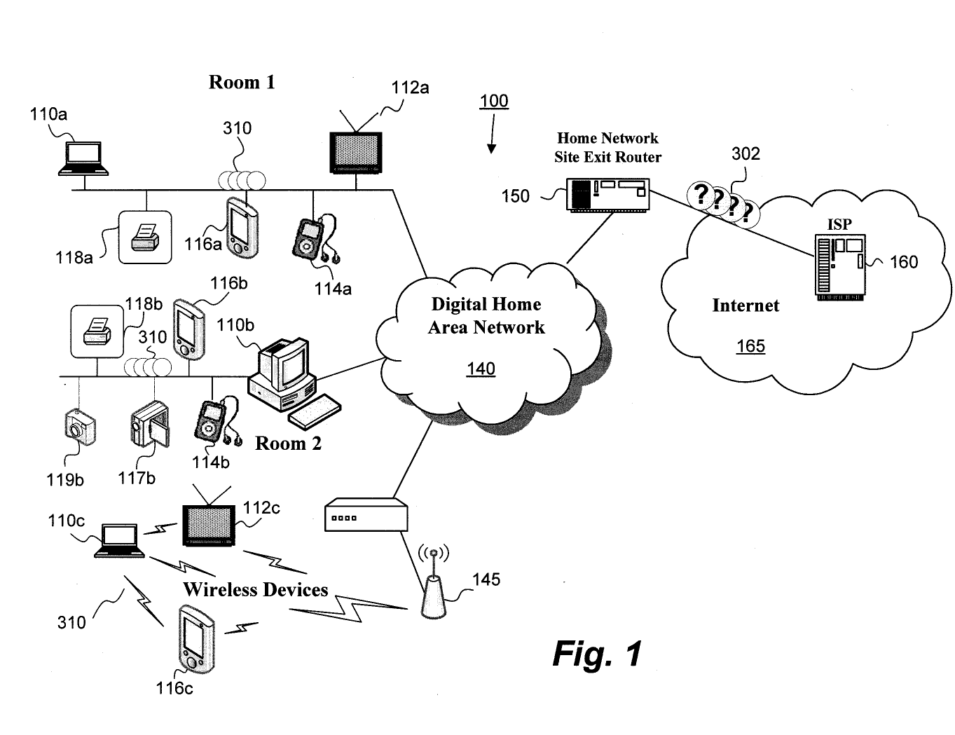

Referring now to FIG. 1, a block diagram of an exemplary home network connecting more than one home network, in accordance with some embodiments of the inventions, is illustrated. Specifically, a host platform 110a, 110b, or 110c is illustrated as being coupled to a variety of different remote home network devices (e.g. 112-165). The host platform 110a, 110b, or 110c receives device specific information 310 from each of the network devices 112-165 connected to the network. In various embodiments, the device specific information may be shared by each of the host platforms and/or network devices within the network. The digital home network 100 may also connect by way of a home network site exit (aka gateway) router 150 to an Internet Service Provider (ISP) 160. The ISP 160 provides the home network devices with access to the Internet 165, a worldwide, publicly accessible network of interconnected computer networks that transmit data by packet switching using standard communication protocols.

The network connections of the various network capable devices may be direct connections as illustrated by the host platform 110a, media center 112a, personal multimedia device 114a, personal digital assistant 116a, and printer 118a in Room 1 or indirect connections using another network capable device as illustrated in Room 2 by the host platform 110b connecting the personal multimedia device 114b, personal digital assistant 116b, the video camera 117b, the printer 118b, and the camera 119b to the home network 100. The digital home network 100 may include both wired and wireless connections to the different home network devices (110-165) as seen.

For illustrative purpose, home networks 100 may have a number of complex devices (e.g. 112-165) in which problems arise and induce the consumer to seek technical support. For example, home network 100 may contain a media center 112a in which the Compact Disk Player will not stream certain file formats. More specifically, the consumer may attempt to access information regarding this issue via the internet with a query similar to, “what file formats can my CD Player stream?”

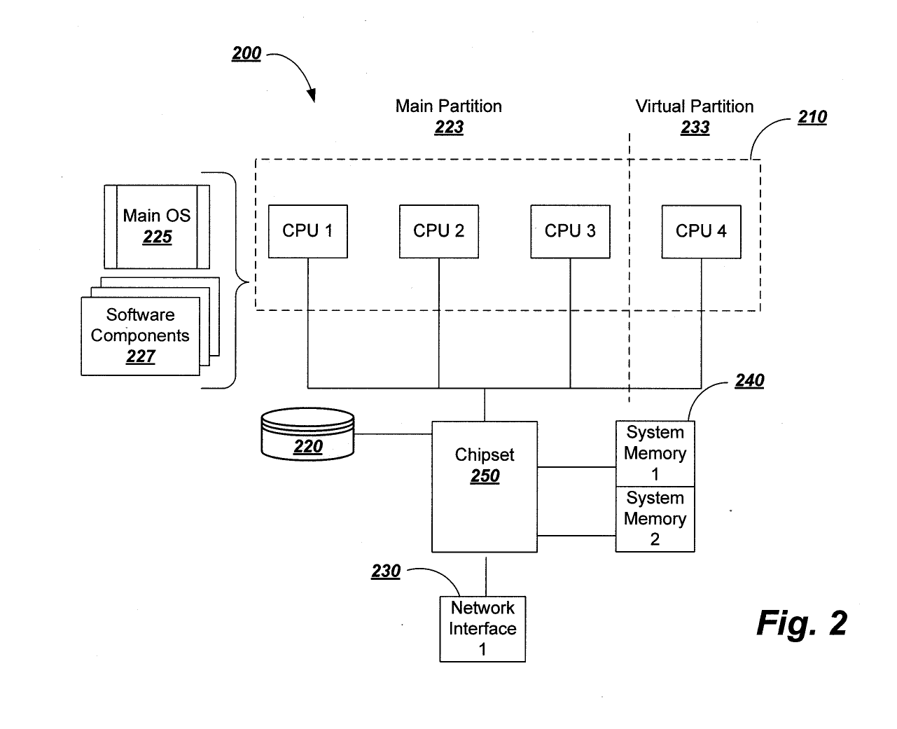

In accordance with one embodiment, digital devices or appliances incorporating the processor host platform described in greater detail in FIG. 2 may be configured to perform the task of modifying the consumer query with device specific information 310 previously or presently obtained by the processor host platform. The modified query 302 may then be submitted to the internet or other technical support service. In the above illustration, the query may be expanded to, “what file formats can my Philips MC-i250 CD Player stream?” In various other embodiments, the host platform may be configured to perform a task of modifying a consumer query, an answer to a consumer query, or both.

Referring to FIG. 2, a block diagram of a multi-processor host platform system 200 is shown in accordance with various embodiments. The system 200 includes a plurality of processors 210, a mass storage device 220, a network interface 230, memory 240, and a chipset 250 coupled to each other as shown.

In one embodiment, the network interface 230 may be configured to monitor the network for packets of device information and descriptions of devices within the network, e.g. device specific information. In various embodiments, the network interface may monitor the network for device specific information from a dedicated virtual partition 233 on the host platform. In this manner, the monitoring and obtaining of device specific information may be accomplished with resources not allocated to the main partition, and accordingly, if the main partition 223 is busy or hibernating, the virtual partition 233 is able to continue monitoring for new devices. In the alternative, the network interface may monitor the network for device specific information from a main partition 233 along side other software components 227.

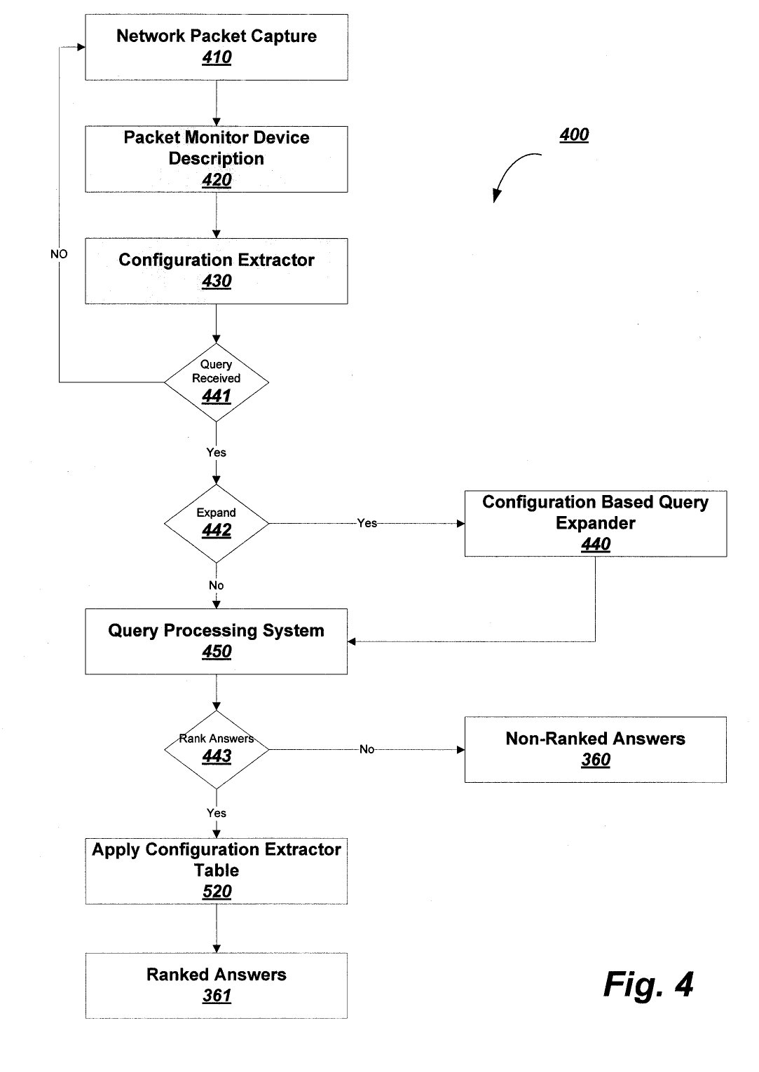

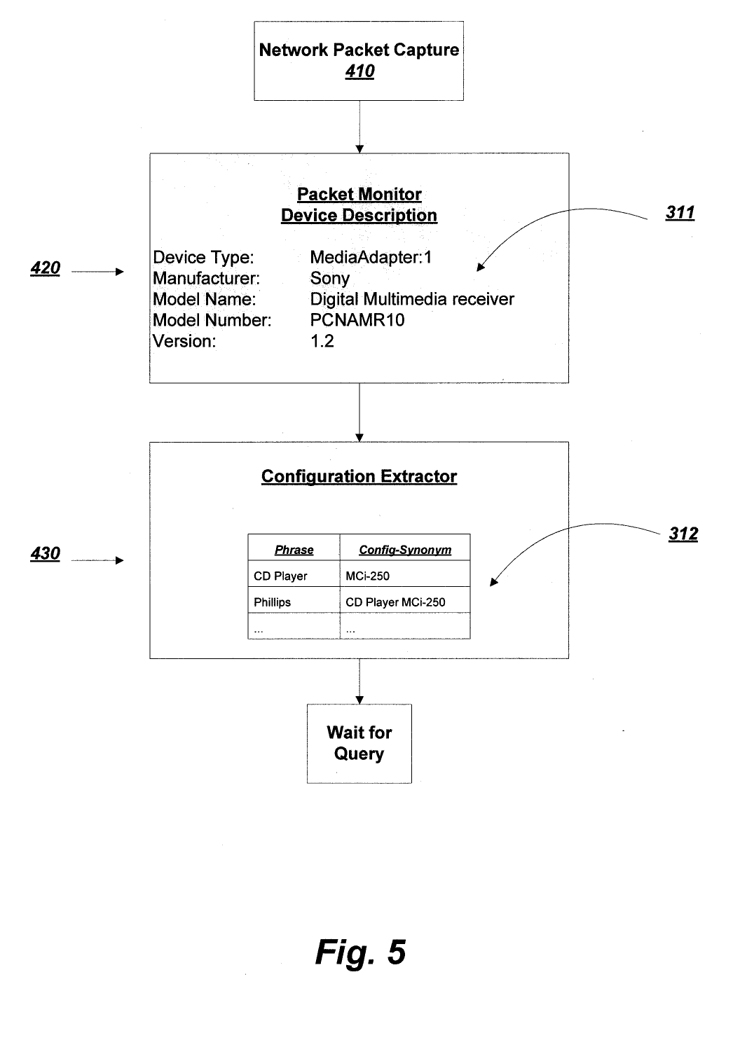

In one embodiment, system memory 240 may store a plurality of programming instructions, as seen in FIGS. 4-5, designed to enable the chipset 250 and the processors 210 to receive a query pertaining to a query subject and modify the query or an answer to the query based, at least in part, on information related to the query subject.

The plurality of processors 210 are the primary resources allocated to the respective partitions and may include any variety of processors known in the art including, in one embodiment, processors having a plurality of processing cores, for example Intel® Pentium® D Processors, Intel® Core™ 2 Extreme, and Intel® Core™ 2 Duo. The processors may be adapted to function within generic computer systems, as well as, Intel® ViiV Embedded Personal Computers (“ViiV EPC”). The plurality of processors 210 may comprise an integrated circuit (“IC”), such as a semiconductor integrated circuit chip. In the embodiment illustrated in FIG. 2, the plurality of processors 210 may include a plurality of central processing units (“CPUs”). Additional or fewer processors may be used in various embodiments. The plurality of processors 210 may be logically and/or physically divided into a plurality of partitions. For example, in the illustrated embodiment, the processors 210 are divided into a main partition 223 and a virtual partition 233.

The at least one primary host processor associated with the main partition 223 is adapted to execute the one or more software components 227 and the operating system 225 which may include, for example, a general operating system such as Windows® operating systems, Linux, etc. The at least one processor associated with virtual partition 233 may be adapted to perform the monitoring and obtaining of device specific information from devices within or added to the network.

System memory 240 may include semiconductor firmware memory, programmable memory, non-volatile memory, read only memory, electrically programmable memory, random access memory, flash memory (which may include, for example, NAND or NOR type memory structures), magnetic disk memory, and/or optical disk memory. Either additionally or alternatively, memory 240 may comprise other and/or later-developed types of computer readable memory. Machines-readable firmware program instructions may be stored in memory 240. As described above, the instructions may be accessed and executed by the main partition 223 and/or the virtual partition 233 of host processor 210.

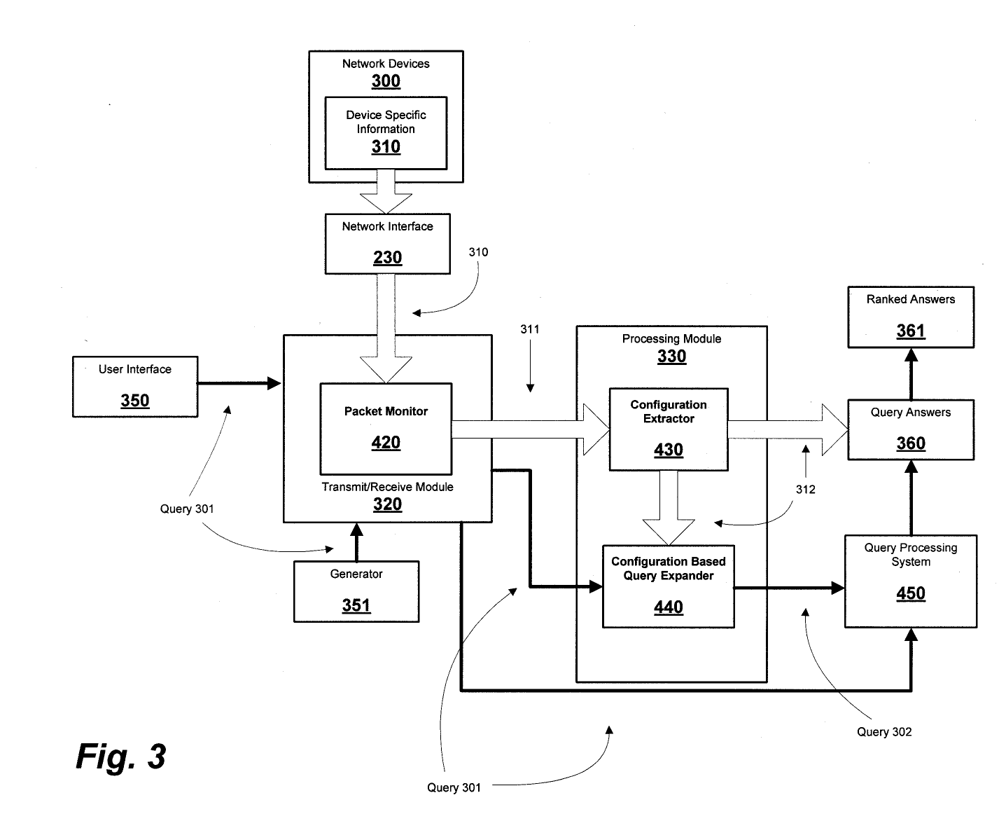

Referring to FIG. 3, an example application of query modification based on home network configurations as presented in FIGS. 1 and 2 is illustrated, in accordance with various embodiments. More specifically, FIG. 3 depicts the task related interactions associated with performing a modification of a query based on device specific information 310 received from network devices 300.

In one embodiment, network devices 300 transmit device specific information 310 to a transmit/receive module 320 via a network interface 230. It is contemplated that the transmit/receive module may be implemented in a hardware configuration or a software configuration. In one embodiment, the transmit/receive module 320 may contain a packet monitor 420. The packet monitor 420 may be integrated into a network interface card (not shown), run in a dedicated virtual partition 233 on a computer system, or run in a main partition 223 along side other applications. In various embodiments, the packet monitor 420 extracts or receives device information from a network device 300. In a preferred embodiment, the packet monitor 420 monitors for Universal Plug and Play advertisements and device descriptions and maintains a time ordered log of the device information it receives. This log allows for query modification, as discussed below, when the network device 300 is not present, not powered on, or incapable of transmitting device specific information 230.

In one embodiment, the packet monitor 420 transmits the time ordered log 311, from the transmit/receive module 320, to a configuration extractor 430 located in a processing module 330. The processing module 330 may be implemented in a hardware configuration or a software configuration similar to the transmit/receive module 320. The configuration extractor 430 takes the device specific information 311 and creates word groups that are correlated with each other. In one embodiment, the word groups are stored in a configuration table 312 as seen in FIG. 5. The configuration table 312 may then be applied, in various embodiments, to a query for the purpose of modification as will be discussed more below.

In various embodiments, a query may be entered by either of a user interface 350 or a generator 351. The user interface may be any one of a keyboard, a mouse, a computer screen, a touch pad, or any other user device capable of submitting a query. The generator 351 may be implemented in a hardware or software configuration.

In one embodiment, the generator 351 automatically generates a query 301 upon an occurrence of a network device being detected or a problem occurring within the network. The query 301 may pertain to common issues regarding the network device or specific issues relating to the network device or the network in general. Similarly, in other embodiments, the user may generate a query 301 upon an occurrence of a problem with a device or a network.

In various embodiments, the query 301 initiated by the generator 351 or the user interface 350 is received by the transmit/receive module 320 and transmitted to at least one of a configuration based query expander 440 in a processing module 330, or a query processing system 450. In one embodiment, the transmit/receive module 320 sends the query 301, as received, directly to a query processing system 450. The query processing system may be any of an internet search engine, a telephony system, an online chat-room, or any other software or hardware configuration capable of receiving queries. In response to receiving the query 301, the query processing system returns query answers 360. In various embodiments, the configuration extractor 430 may then apply the configuration table 312 to the query answers to perform the post processing function of ranking the answers resulting in ranked answers 361. The ranked answers 361 may provide a fast and viable solution to a user's query or, in one embodiment, provide a list of the most likely causes of a problem or a list of the most common problems associated with a device should the generator 351 initiate the query.

In another embodiment, the query 301 is received by the transmit/receive module 320 and transmitted to a configuration based query expander 440 located in a processing module 330. Once a query 301 is received, the configuration based query expander 440 may apply the configuration table 312 from the configuration extractor 430 in order to concatenate or expand the query 301 with synonymous terms from the table 312. The expansion may include simply adding terms, deleting terms while adding others, or simply concatenating terms. In one embodiment, the configuration based query expander 440 then sends the modified query 302 to a query processing system 450 which returns query answers 360. The process of modifying the query prior to submitting it to a query processing system, or pre-processing, may create a more well-framed query which returns more relevant answers.

In yet another embodiment, pre-processing on a query 301 is performed and returns query answers 360. The query answers may then undergo a similar post processing procedure to that describe above in which the configuration extractor applies the configuration table 312 to the pre-processed query answers returning ranked answers 361. In such a manner the system may incorporate pre-processing and post processing; only post processing; or only pre-processing.

Referring now to FIG. 4-5, methods, in accordance with various embodiments, are described in terms of computer firmware, software, and hardware with reference to a series of flow diagrams. In various embodiments, portions of the operations to be performed by a host platform device may constitute state machines or computer programs made up of computer-executable instructions. These instructions are typically maintained in a storage medium accessible by the host platform device and/or remote devices.

A machine-accessible medium or storage medium includes any mechanism that provides (i.e., stores and/or transmits) information in a form readable by a machine (e.g. a computer). For example, a storage medium includes read only memory (“ROM”), random access memory (“RAM”), magnetic disk storage media, optical storage media, flash memory devices, electrical, optical, acoustical or other form of propagated signals (e.g., carrier waves, infrared signals, digital signals), and the like.

Describing the methods by reference to a flow diagram enables one skilled in the art to develop such programs, including instructions to carry out the methods on suitably configured host platforms and/or remote devices. In various embodiments, at least one of the processors of a suitably configured host platform and/or remote device executes the instructions from the storage medium. In various embodiments, the computer-executable instructions may be written in a computer programming language or may be embodied in firmware logic, reconfigurable logic, a hardware description language, a state machine, an application-specific integrated circuit, or combinations thereof. If written in a programming language conforming to a recognized standard, such instructions may be executed on a variety of hardware platforms and may interface with a variety of operating systems.

The present various embodiments are not described with reference to any particular programming language. It will be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of saying that execution of the software by a network device causes the processor of the computer to perform an action or produce a result.

Referring to FIG. 4, a flow diagram of a portion of the operations of a host platform as shown in FIGS. 1 and 2 is shown in further detail, in accordance with various embodiments. The host platform device 400 captures network packets in block 410. In one embodiment, the network packets are captured through a packet monitor device integrated into a network interface card. The network packets or device specific information is then extracted by a packet monitor in block 420. The packet monitor may, in various embodiments and as seen in further detail in FIG. 5, extract information such as model number, manufacturer name, or firmware version. In one embodiment, the device specific information is passed from the packet monitor to the configuration extractor in block 430. The configuration extractor takes the device specific information and creates word groups which correlate with the device specific information. This process may be continual as seen by the loop created by block 441. Once a query is initiated, a decision is made on whether post processing or pre-processing, as described above with reference to FIG. 4, is desired. This determination is embodied in block 442.

If, in one embodiment, a decision is made not to perform pre-processing, the query will be transmitted, as received, to a query processing system 450. The query processing system then returns answers on which a decision may be made to perform post processing, block 443. If post processing is desired, the answers are ranked and/or re-ranked using the information contained in the configuration extractor table 312 resulting in ranked answers 361.

If, in one embodiment, a decision at block 442 is made to perform pre-processing, the query is then transmitted to block 440 where the configuration based query expander concatenates or expands the query based on the configuration extractor table 312 created by the configuration extractor 430. The modified query may then be transmitted to a query processing system at block 450. The query processing system returns answers to the modified query and at block 443 a decision may be made whether to perform post processing on the pre-processed answers or simply return the pre-processed answers unranked at block 360. In such a way, both pre-processing and post processing may be accomplished independently or together to return more relevant answers.

Referring to FIG. 5, a flow diagram of a portion of the operations of a platform device in a home network, as presented in FIGS. 1-3, is shown in further detail, in accordance with various embodiments. The host platform device captures network packet information in block 410. In one embodiment, the packet monitor extracts the device specific information 310 and creates a time ordered log 311 in block 420. The device specific information 311 may comprise the device type, the manufacturer, the model name, the model number and the firmware version as shown in block 420. In a preferred embodiment, the packet monitor monitors the network for Universal Plug-and-Play advertisement messages and device descriptions of devices within the network. In various embodiments, the configuration extractor in block 430 creates a configuration extractor table 312. The configuration extractor table 312 comprises device descriptions and word groups correlated to the device specific information 310 and time ordered log 311 to be used for modification as previously discussed.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving, by a processor, a request to submit a query pertaining to a query subject; and
modifying, by the processor, the query and/or an answer to the query based, at least in part, on information related to the query subject accessible to the processor, to provide a more relevant answer to the query.

2. The method of claim 1, wherein the receiving comprises receiving the request to submit the query pertaining to a device; and
the modifying comprises modifying the query and/or the answer to the query based, at least in part, on device specific information related to the device.

3. The method of claim 2, wherein the device is a device within a network.

4. The method of claim 1, further comprising submitting the modified query to a query processing system and wherein the modifying comprises expanding, by the processor, the query based, at least in part, on information related to the query subject.

5. The method of claim 1, further comprising submitting the query as received to a query processing system and wherein the modifying comprises ranking the answer to the query based, at least in part, on information related to the query subject.

6. The method of claim 1, further comprising obtaining, by the processor, the information related to the query subject and wherein the modifying comprises modifying, by the processor, the query and/or the answer to the query based, at least in part, on the information obtained by the processor.

7. The method of claim 6, wherein the obtaining comprises obtaining, by the processor, the information related to the query subject prior to receiving the request to submit the query pertaining to the query subject.

8. The method of claim 1, further comprising automatically generating, by a generator operated by the processor, the query pertaining to the query subject and the request to submit the query and wherein the receiving comprises receiving, by a modifier of the processor from the generator, the automatically generated request to submit the automatically generated query pertaining to the query subject.

9. The method of claim 1, further comprising manually generating by a user the query pertaining to the query subject and the request to submit the query and wherein the receiving comprises receiving, by the processor, the manually generated request to submit the manually generated query pertaining to the query subject, in a form of manual inputs from the user.

10. The method of claim 1, further comprising monitoring, by the processor, a network for Universal Plug and Play advertisements and device descriptions and wherein the modifying comprises modifying, by the processor, the query and/or the answer to the query based at least in part on the Universal Plug and Play advertisements and device descriptions.

11. The method of claim 1, wherein the modifying comprises modifying by the processor the query and/or the answer to the query based on at least one of a model number, a manufacturer's name, or a firmware version.

12. An apparatus comprising:
a transmit/receive module to receive a request to submit a query pertaining to a query subject; and
a processing module coupled to the transmit/receive module configured to modify the query and/or an answer to the query based, at least in part, on information related to the query subject accessible to the processor, to provide a more relevant answer to the query.

13. The apparatus of claim 12, wherein the transmit/receive and processing modules are adapt to receive and process a request where the query subject of the query is a device; and the information related to the device is device specific information.

14. The apparatus of claim 13, wherein the device is within a network.

15. The apparatus of claim 12, wherein the processing module is configured to expand the query based, at least in part, on information related to the query subject.

16. The apparatus of claim 12, wherein the processing module is configured to rank an answer to the query or another query derived from the received query based, at least in part, on information related to the query subject.

17. The apparatus of claim 12, wherein the processing module is further configured to obtain the information related to the query subject.

18. The apparatus of claim 12, further comprising a generator coupled to the transmit/receive module and configured to automatically generate the query pertaining to the query subject and the request to submit the query, for the transmit/receive module.

19. The apparatus of claim 12, wherein the transmit/receive module is further configured to receive a manually inputted query pertaining to the query subject and a manual inputted request to submit the manually inputted query.

20. The apparatus of claim 12, wherein the processing module is further configured to monitor a network for Universal Plug and Play advertisements and/or device descriptions and wherein the processing module is configured to modify the query and/or the answer to the query based, at least in part, on the Universal Plug and Play advertisements and/or device descriptions.

21. An article of manufacture comprising:
a storage medium; and
a plurality of programming instructions stored on the storage medium and designed to enable a device to:
receive a request to submit a query pertaining to a query subject; and
modify the query and/or an answer to the query based, at least in part, on information related to the query subject accessible to the device, to provide a more relevant answer to the query.

22. The article of manufacture of claim 21, wherein the programming instructions are further designed to enable the device to submit the modified query to a query processing system and wherein the programming instructions are designed to enable the device to expand the query based, at least in part, on information related to the query subject.

23. The article of manufacture of claim 21, wherein the programming instructions are further designed to enable the device to submit the query, as received, to a query processing system and wherein the programming instructions are designed to enable the device to rank an answer to the query or another query derived from the received query based, at least in part, on information related to the query subject.

24. The article of manufacture of claim 21, wherein the programming instructions are further designed to enable the device to automatically generate, by a generator, the query and the request to submit the query and wherein the programming instructions are designed to enable the device to receive, by a modifier of the device from the generator, the automatically generated request to submit the automatically generated query pertaining to the query subject.

25. The article of manufacture of claim 21, wherein the programming instructions are further designed to enable the device to receive a manually inputted query and request to submit the query and wherein the programming instructions are designed to enable a device to receive the manually inputted request to submit the manually inputted query pertaining to the query subject.

26. A system comprising:
a network interface;
a transmit/receive module, coupled to the network interface, to receive a request to submit a query pertaining to a query subject; and
a processing module coupled to the transmit/receive module configured to modify the query and/or an answer to the query based, at least in part, on information related to the query subject accessible to the processor, to provide a more relevant answer to the query.

27. The system of claim 26, wherein the processing module is configured to expand the query based, at least in part, on information related to the query subject.

28. The system of claim 26, wherein the processing module is configured to rank an answer to the query or another query derived from the received query based, at least in part, on information related to the query subject.

29. The system of claim 26, wherein the network interface is designed to enable the transmit/receive module to obtain the information related to the query subject.

30. The system of claim 26 wherein the network interface is designed to enable the transmit/receive module to monitor a network for Universal Plug and Play advertisements and device descriptions related to the query subject.
